(19) United States
(12) Patent Application Publication
(10) Pub. No.: US 2006/0278822 A1
(43) Pub. Date: Dec. 14, 2006

(54) System for studying power of laser beam

(75) Inventor: Sang Yeal Park, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/385,729

(22) Filed: Mar. 22, 2006

(30) Foreign Application Priority Data
May 26, 2005 (KR) 2005-44365

(51) Int. Cl. G01D 18/00

(52) U.S. Cl. 250/252.1

(57) ABSTRACT

A laser beam power studying system for studying laser power in a reproducing mode and a recording mode of an optical recording apparatus. A laser beam having different powers in the recording mode and the reproduction mode is emitted and a first part of the laser beam is measured. A second part of the laser beam is measured by a front photo diode and a signal corresponding to the measurement by the front photo diode is amplified by a single amplifier in both reproducing recording study operations. Relational expression between measurements of the first part of the laser beam and the second part of the laser beam at different power levels of the laser beam is developed for both the recording and reproducing modes.

### CROSS-REFERENCE TO RELATED APPLICATIONS

This application claims the benefit of Korean Patent Application No. 2005-44365, filed on May 26, 2005 in the Korean Intellectual Property Office, the disclosure of which is incorporated herein by reference.

### BACKGROUND OF THE INVENTION

1. Field of the Invention

The present invention relates to a system for studying power of a laser beam, and, more particularly, to a laser beam power studying system for presetting references for control of power of a laser beam in a manufacturing process of an optical recording/reproduction apparatus.

2. Description of the Related Art

In general, an optical recording/reproduction apparatus includes a recording automatic power control (APC) circuit controlling power of a laser beam in a recording operation, and a reproduction APC circuit controlling power of a laser beam in a reproduction operation, and is adapted to maintain the power of the laser beam at a predetermined value through the use of the recording or reproduction APC circuit when recording or reproducing data on an optical disc.

Such a conventional optical recording/reproduction apparatus is disclosed in Korean Patent Laid-open Publication No. 2004-2232. As disclosed in the Korean publication 2004-2232, the conventional optical recording/reproduction apparatus includes a radio frequency (RF) unit including recording and reproduction APC circuits, a read only memory (ROM) storing offset values of the recording and reproduction APC circuits for outputs of optimum recording laser beam power and optimum reproduction laser beam power, a voltage value of the optimum recording laser beam power, and a voltage value of the optimum reproduction laser beam power, a microcomputer setting offsets of the recording and reproduction APC circuits, a voltage of recording laser beam power and a voltage of reproduction laser beam power on the basis of the values stored in the ROM, respectively, when the optical recording/reproduction apparatus is powered on, and an optical pickup adjusting the voltage of the recording or reproduction laser beam power in response to an output signal from a front photodiode fed back to the optical pickup in a recording or reproduction mode. With this configuration, the conventional optical recording/reproduction apparatus is adapted to properly control the laser beam power in the reproduction or recording mode.

The conventional optical recording/reproduction apparatus utilizes the offset values and voltage values stored in the ROM as references for the control of the reproduction and recording laser beam powers. Although not disclosed in detail in the above publication, these values are obtained by studying the reproduction and recording laser beam powers in advance in a manufacturing process of the optical recording/reproduction apparatus. At this time, a reproduction laser beam power studying operation and a recording laser beam power studying operation are performed separately from each other, thus involving separate studying paths.

In the reproduction laser beam power studying operation, the optical pickup outputs photovoltage signals of different levels depending on different powers of a laser beam. The photovoltage signals are amplified by a first amplifier of an analog signal processor (ASP) and then input to the microcomputer. Then, the microcomputer stores the laser beam powers and the levels of output voltages from the first amplifier of the ASP and controls the reproduction laser beam power using the stored values.

Similarly, in the recording laser beam power studying operation, the optical pickup outputs photovoltage signals of different levels depending on different powers of a laser beam. The photovoltage signals are amplified by a second amplifier of the ASP and then inputted to the microcomputer. Then, the microcomputer stores the laser beam powers and the levels of output voltages from the second amplifier of the ASP and controls the recording laser beam power using the stored values.

However, such a conventional laser beam power studying system is disadvantageous in that, because the different amplifiers are used in the recording laser beam power studying operation and the reproduction laser beam power studying operation, the accurate setting of references for laser beam power control may be difficult due to gain and offset differences between the amplifiers. In addition, the recording laser beam power studying path and the reproduction laser beam power studying path must be controlled separately from each other, thereby increasing load on the microcomputer.

Moreover, the use of inaccurate references for laser beam power control may cause the laser beam power control to be performed inaccurately or for a longer time.

### SUMMARY OF THE INVENTION

Therefore, an aspect of the invention is to provide a laser beam power studying system wherein a same amplifier is used in a recording laser beam power studying operation and a reproduction laser beam power studying operation, thus raising reliability of the laser beam power studying results and simplifying the circuit configuration of the system.

The above and/or other aspects are achieved by providing a laser beam power studying system comprising: a laser diode emitting a laser beam having different powers in a recording mode and a reproduction mode; a front photodiode receiving a part of the laser beam from the laser diode and converting the received laser beam part into a photocurrent signal; an analog signal processor amplifying a photovoltage signal obtained by performing a current/voltage conversion operation with respect to the photocurrent signal, with reference to a reference voltage signal, to provide an output voltage signal; and a microcomputer deriving an output voltage signal-to-laser beam power relational expression in a reproduction laser beam power studying operation or a recording laser beam power studying operation by repeatedly varying the laser beam power in the reproduction or recording mode, wherein the analog signal processor includes a single amplifier amplifying the photovoltage signal in the reproduction laser beam power studying operation and the recording laser beam power studying operation.

The single amplifier may be set to different gains and different offsets in the reproduction laser beam power studying operation and the recording laser beam power studying operation.

The analog signal processor may further include: a gain storage unit storing a reproduction gain and a recording gain to be applied to the amplifier in the reproduction laser beam power studying operation and the recording laser beam power studying operation, respectively; and a first multiplexer selecting one of the reproduction gain and the recording gain stored in the gain storage unit according to whether the system is in the reproduction laser beam power studying operation or the recording laser beam power studying operation, and applying the selected gain to the amplifier as the gain to be set in the amplifier in the reproduction laser beam power studying operation or the recording laser beam power studying operation. As used in this application, an expression of the form one of A and B and expression of the form A or B have a same meaning.

The analog signal processor may further include: an offset storage unit storing a reproduction offset and a recording offset to be applied to the amplifier in the reproduction laser beam power studying operation and the recording laser beam power studying operation, respectively; and a second multiplexer selecting one of the reproduction offset and the recording offset stored in the offset storage unit according to whether the system is in the reproduction laser beam power studying operation or the recording laser beam power studying operation, and applying the selected offset to the amplifier as the offset to be set in the amplifier in the reproduction laser beam power studying operation or the recording laser beam power studying operation.

The analog signal processor may further include a level shifter set to different levels in the reproduction laser beam power studying operation and the recording laser beam power studying operation, and the level shifter may shift the photovoltage signal to the different levels in the reproduction laser beam power studying operation and the recording laser beam power studying operation and supply the level-shifted photovoltage signal to the amplifier.

The analog signal processor may further include: a level storage unit storing a reproduction level and a recording level to be applied to the level shifter, respectively, in the reproduction laser beam power studying operation and the recording laser beam power studying operation; and a third multiplexer selecting one of the reproduction level and the recording level stored in the level storage unit according to whether the system is in the reproduction laser beam power studying operation or the recording laser beam power studying operation, and applying the selected level to the level shifter as the level to be set in the level shifter in the reproduction laser beam power studying operation or the recording laser beam power studying operation.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing a configuration of a laser beam power studying system according to an embodiment of the present invention; and

FIG. 2 is a detailed block diagram of an analog signal processor shown in FIG. 1.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

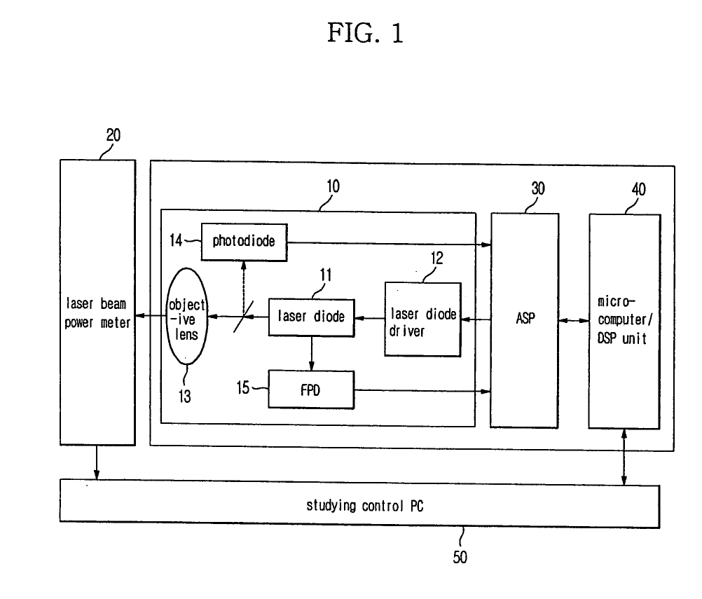

FIG. 1 shows a configuration of a laser beam power studying system according to an exemplary embodiment of the present invention. As shown in FIG. 1, the laser beam power studying system comprises a pickup 10, a laser beam power meter 20, an analog signal processor (ASP) 30, a microcomputer/digital signal processor (DSP) unit 40, and a studying control personal computer (PC) 50.

The pickup 10 includes a laser diode 11 emitting a laser beam, a laser diode driver 12 driving the laser diode 11, an objective lens 13 focusing the laser beam from the laser diode 11 on an optical disc to form a spot thereon, a photodiode 14 receiving a laser beam reflected from the optical disc and converting the received laser beam into a current signal, and a front photodiode (FPD) 15 receiving a part of the laser beam from the laser diode 11 and converting the received laser beam part into a photocurrent signal corresponding to an amount of the received laser beam. The laser beam emitted from the laser diode 11 is fed mostly to the objective lens 13, and partially to the FPD 15.

The laser diode driver 12 includes a register (not shown) storing laser diode drive voltage values of multiple levels to enable the laser diode 11 to emit laser beams with multiple power levels in a laser beam power studying operation. These drive voltage values are set by the microcomputer/DSP unit 40. In the laser beam power studying operation, the laser diode driver 12 sequentially supplies the laser diode drive voltage values stored in the register to the laser diode 11 to vary power of the laser beam to be emitted from the laser diode 11.

The photocurrent signal from the FPD 15 is converted into a photovoltage signal Vfpdo by a current to voltage (I/V) converter 17 and then input to the ASP 30. A reference voltage signal Vref is also applied to the ASP 30. The FPD 15 has a characteristic of outputting a photocurrent signal of a lower level when receiving a laser beam with larger power.

The laser beam power meter 20 measures power of a laser beam passed through the objective lens 13.

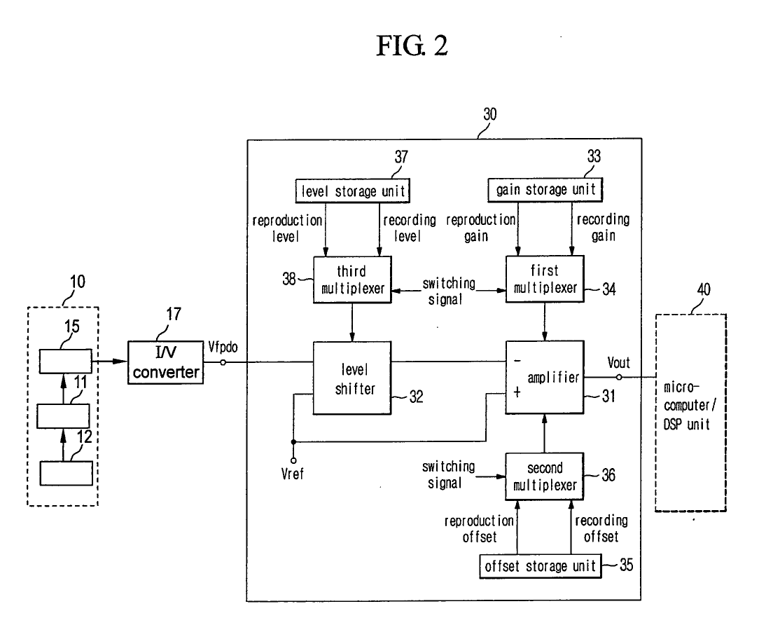

Referring now to FIG. 2, the ASP 30 includes a level shifter 32, a level storage unit 37, a first multiplexer 34, an amplifier 31, a gain storage unit 33, a second multiplexer 36, an offset storage unit 35, and a third multiplexer 38.

The level shifter 32 shifts the photovoltage signal Vfpdo from the pickup 10 to different levels in a reproduction laser beam power studying operation and a recording laser beam power studying operation. For example, in a playback-only system, the pickup 10 outputs a photovoltage signal Vfpdo higher than a specific voltage in a reproduction mode. In contrast, in a recording/reproduction system, the pickup 10 outputs a photovoltage signal Vfpdo lower than the specific voltage in a recording mode. The level shifter 32 adjusts the photovoltage signal Vfpdo from the pickup 10 to the specific voltage.

The level storage unit 37 is a register, and stores a reproduction level that is the level to which the photovoltage signal Vfpdo from the pickup 10 is to be shifted by the level shifter 32 in the reproduction laser beam power studying operation, and a recording level that is the level to which the photovoltage signal Vfpdo from the pickup 10 is to be shifted by the level shifter 32 in the recording laser beam power studying operation.

The third multiplexer 38 selects one of the reproduction level and the recording level stored in the level storage unit 37 in response to a switching signal from the microcomputer/DSP unit 40 and applies the selected level to the level shifter 32.

The amplifier 31 has a plus terminal receiving the reference voltage signal Vref and a minus terminal for receiving the level-shifted photovoltage signal Vfpdo. The amplifier 31 is also set to different gains and different offsets in the reproduction laser beam power studying operation and the recording laser beam power studying operation. As a result, in the reproduction laser beam power studying operation and the recording laser beam power studying operation, the level-shifted photovoltage signal Vfpdo is amplified with the different gains and different offsets and then provided as an output voltage signal Vout.

The gain storage unit 33 is a register, and stores a reproduction gain to be applied to the amplifier 31 in the reproduction laser beam power studying operation, and a recording gain to be applied to the amplifier 31 in the recording laser beam power studying operation.

The first multiplexer 34 selects one of the reproduction gain and the recording gain stored in the gain storage unit 33 in response to the switching signal from the microcomputer/DSP unit 40 and apply the selected gain to the amplifier 31 such that the amplifier 31 is set to the reproduction gain in the reproduction laser beam power studying operation and to the recording gain in the recording laser beam power studying operation.

The offset storage unit 35 is a register, and stores a reproduction offset to be applied to the amplifier 31 in the reproduction laser beam power studying operation, and a recording offset to be applied to the amplifier 31 in the recording laser beam power studying operation.

The second multiplexer 36 selects one of the reproduction offset and the recording offset stored in the offset storage unit 35 in response to the switching signal from the microcomputer/DSP unit 40 and applies the selected offset to the amplifier 31 such that the amplifier 31 is set to the reproduction offset in the reproduction laser beam power studying operation and to the recording offset in the recording laser beam power studying operation.

The microcomputer/DSP unit 40 stores the output voltage signal Vout from the ASP 30 and derives a correlation between the stored output voltage signal Vout and the corresponding laser beam power. The microcomputer/DSP unit 40 also receives analog signals other than the output voltage signal Vout from the ASP 30, converts the received analog signals into digital signals, processes the converted digital signals, and controls the pickup 10 and ASP 30 depending on the processed signals. The studying control PC 50 controls the entire operation of the laser beam power studying system. Although the microcomputer/DSP unit 40 is disclosed in the present embodiment to be a single block, the microcomputer and the DSP may be implemented as separate blocks.

A description will hereinafter be given of the operation of the laser beam power studying system described above with reference to FIGS. 1 and 2. Notably, it is impractical to actually measure and control power of a laser beam passed through the objective lens 13 of the pickup 10 in a recording or reproduction mode of an optical recording/reproduction apparatus. For this reason, references for control of power of a laser beam are preset through the recording or reproduction laser beam power studying operation in a manufacturing process of the optical recording/reproduction apparatus and the laser beam power is controlled in the recording or reproduction mode on the basis of the preset references.

The reproduction laser beam power studying operation is performed by acquiring a plurality of sets of data. First, the microcomputer/DSP unit 40 supplies the switching signal to the first multiplexer 34 and second multiplexer 36 such that the amplifier 31 is set to the reproduction gain and reproduction offset. The microcomputer/DSP unit 40 also supplies the switching signal to the third multiplexer 38 such that the reproduction level is applied to the level shifter 32. Then, for a first set of data, the microcomputer/DSP unit 40 applies a first one of n (where n is a natural number>2) reproduction laser diode drive voltage values stored in the register of the laser diode driver 12 to the laser diode 11 such that the laser diode 11 emits a laser beam of power corresponding to the first reproduction laser diode drive voltage value.

The laser beam emitted from the laser diode 11 is passed through the objective lens 13 and the power thereof is then measured by the laser beam power meter 20. The FPD 15 receives a part of the laser beam from the laser diode 11 and converts the received part into a photocurrent signal, which is in turn converted into a photovoltage signal Vfpdo and input to the level shifter 32. The level shifter 32 shifts the photovoltage signal Vfpdo to the reproduction level and outputs the level-shifted photovoltage signal Vfpdo to the amplifier 31. The amplifier 31 amplifies the level-shifted photovoltage signal Vfpdo input thereto by the reproduction gain and outputs the amplified signal as an output voltage signal Vout. The output voltage signal Vout from the amplifier 31 is transferred to the microcomputer/DSP unit 40, which stores the transferred output voltage signal Vout and a corresponding reproduction laser beam power value. The Vout and the corresponding laser beam power level value are included in the data set.

Thereafter, the microcomputer/DSP unit 40 determines whether a predetermined number of data sets have been acquired. Upon determining that the predetermined number of data sets have not been acquired, the microcomputer/DSP unit 40 repeats the data acquisition using another one of the stored reproduction laser diode drive values. However, if it is determined that the predetermined number of data sets have been acquired, the microcomputer/DSP unit 40 obtains an output voltage signal-to-reproduction laser beam power relational expression based on a plurality of stored output voltage signals Vout and a plurality of stored reproduction laser beam powers (i.e., the plurality of the data sets) and stores the obtained relational expression. Note that the reproduction laser diode drive voltage values stored in the register of the laser diode driver 12 are sequentially applied to the laser diode 11 so that a laser beam with different power is emitted from the laser diode 11 during the acquisition of each data set.

The output voltage signal-to-reproduction laser beam power relational expression, obtained in the above manner, becomes a reference for control of reproduction laser beam power in the optical recording/reproduction apparatus with the pickup 10 shown in FIGS. 1 and 2.

The recording laser beam power studying operation is performed by acquiring a second plurality of sets of data. First, the microcomputer/DSP unit 40 supplies the switching signal to the first multiplexer 34 and second multiplexer 36 such that the amplifier 31 is set to the recording gain and recording offset. The microcomputer/DSP unit 40 also supplies the switching signal to the third multiplexer 38 such that the recording level is applied to the level shifter 32. Then, for a first set of the second plurality of sets of data, the microcomputer/DSP unit 40 applies a first one of n (where n is a natural number>2) recording laser diode drive voltage values stored in the register of the laser diode driver 12 to the laser diode 11 such that the laser diode 11 emits a laser beam of power corresponding to the first recording laser diode drive voltage value.

The laser beam emitted from the laser diode 11 is passed through the objective lens 13 and the power thereof is then measured by the laser beam power meter 20. The FPD 15 receives a part of the laser beam from the laser diode 11 and converts the received part into a photocurrent signal, which is in turn converted into a photovoltage signal Vfpdo and then inputted to the level shifter 32. The level shifter 32 shifts the photovoltage signal Vfpdo to the recording level and outputs the level-shifted photovoltage signal Vfpdo to the amplifier 31. The amplifier 31 amplifies the level-shifted photovoltage signal Vfpdo inputted thereto by the recording gain and outputs the amplified signal as an output voltage signal Vout. The output voltage signal Vout from the amplifier 31 is transferred to the microcomputer/DSP unit 40, which then stores the transferred output voltage signal Vout and the corresponding recording laser beam power.

Subsequently, the microcomputer/DSP unit 40 determines whether a predetermined number of data sets of the second plurality of data sets have been acquired. If it is determined that the predetermined number of the second plurality of data sets has not been acquired, the microcomputer/DSP unit 40 repeats the data acquisition using another one of the stored recording laser diode drive values. However, if it is determined that the predetermined number data sets have been acquired, the microcomputer/DSP unit 40 obtains an output voltage signal-to-recording laser beam power relational expression based on a plurality of stored output voltage signals Vout and a plurality of stored recording laser beam powers (i.e., the second plurality of the data sets) and stores the obtained relational expression. Note that the recording laser diode drive voltage values stored in the register of the laser diode driver 12 are sequentially applied to the laser diode 11 so that a laser beam with different power can be emitted from the laser diode 11 during the acquisition of each data set. The predetermined number of times the data acquisition is repeated determines a quality of the relational expression. For better results, the predetermined number should be at least three in the reproducing mode and at least three in the recording mode.

The output voltage signal-to-recording laser beam power relational expression, obtained in the above manner, becomes a reference for control of recording laser beam power in the optical recording/reproduction apparatus with the pickup 10 shown in FIGS. 1 and 2.

As set forth in the above description, aspects of the present invention provide a laser beam power studying system wherein the same amplifier is used in a recording laser beam power studying operation and a reproduction laser beam power studying operation. Therefore, it is possible to prevent references for laser beam power control from being inaccurately set due to the use of separate amplifiers with different gains and different offsets in the recording laser beam power studying operation and the reproduction laser beam power studying operation.

In addition, the use of one amplifier in an analog signal processor, not two amplifiers as in the conventional system, simplifies the circuit configuration of the present system.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A laser beam power studying system comprising:
a laser diode emitting a laser beam having different powers in a recording mode and a reproduction mode;
a front photodiode receiving a part of the laser beam from the laser diode and converting the received laser beam part into a photocurrent signal;
an analog signal processor amplifying a photovoltage signal obtained by performing a current/voltage conversion operation with respect to the photocurrent signal, with reference to a reference voltage signal, to provide an output voltage signal; and
a microcomputer deriving a relational expression of the laser beam power to the output voltage signal in a reproduction laser beam power studying operation or a recording laser beam power studying operation by repeatedly varying the laser beam power in the reproduction or recording mode, respectively,
wherein the analog signal processor includes a single amplifier for amplifying the photovoltage signal in the reproduction laser beam power studying operation and the recording laser beam power studying operation.

2. The laser beam power studying system as set forth in claim 1, wherein the single amplifier is set to different gains and different offsets in the reproduction laser beam power studying operation and the recording laser beam power studying operation.

3. The laser beam power studying system as set forth in claim 2, wherein the analog signal processor further comprises:
a gain storage unit storing a reproduction gain and a recording gain to be applied to the single amplifier in the reproduction laser beam power studying operation and the recording laser beam power studying operation, respectively; and
a multiplexer selecting the reproduction gain or the recording gain stored in the gain storage unit according to whether the system is in the reproduction laser beam power studying operation or the recording laser beam power studying operation, respectively, the multiplexer applying the selected gain to the amplifier as the gain to be set in the amplifier in the reproduction laser beam power studying operation or the recording laser beam power studying operation, respectively.

4. The laser beam power studying system as set forth in claim 2, wherein the analog signal processor further comprises:
an offset storage unit storing a reproduction offset and a recording offset to be applied to the amplifier in the reproduction laser beam power studying operation and the recording laser beam power studying operation, respectively; and
a multiplexer selecting the reproduction offset or the recording offset stored in the offset storage unit according to whether the system is in the reproduction laser beam power studying operation or the recording laser beam power studying operation, and applying the selected offset to the amplifier as the offset to be set in the amplifier in the reproduction laser beam power studying operation or the recording laser beam power studying operation.

5. The laser beam power studying system as set forth in claim 2, wherein the analog signal processor further comprises:
a level shifter set to different levels in the reproduction laser beam power studying operation and the recording laser beam power studying operation, the level shifter shifting the photovoltage signal to the different levels in the reproduction laser beam power studying operation and the recording laser beam power studying operation and supplying the level-shifted photovoltage signal to the amplifier.

6. The laser beam power studying system as set forth in claim 5, wherein the analog signal processor further comprises:
a level storage unit storing a reproduction level and a recording level to be applied to the level shifter, respectively, in the reproduction laser beam power studying operation and the recording laser beam power studying operation; and
a multiplexer selecting the reproduction level or the recording level stored in the level storage unit according to whether the system is in the reproduction laser beam power studying operation or the recording laser beam power studying operation, and applying the selected level to the level shifter as the level to be set in the level shifter in the reproduction laser beam power studying operation or the recording laser beam power studying operation.

7. A laser beam power studying system for studying laser beam power in a reproducing mode and a recording mode, the system comprising:
a laser diode;
a laser diode driver selectively driving the laser diode in the reproducing mode or the recording mode according to a reproducing level value or a recording level value, respectively;
a level storage unit storing a plurality of the reproducing level values and a plurality of the recording level values;
a laser beam power meter measuring a power of a first part of the emitted laser beam and outputting a measured result;
a front photodiode measuring a second part of the emitted laser beam and outputting a corresponding signal;
an analog signal processor comprising:
a level shifter selectively shifting a level of the front photodiode signal by a first shifted value in the reproducing mode and a second shifted value in the recording mode, and
an amplifier selectively amplifying the shifted front photodiode signal at a first gain in the reproducing mode and a second gain in the recording mode; and
a microcomputer:
controlling the laser diode driver, the level storage unit, the level shifter and the amplifier to collect a first plurality of data sets in the reproducing mode and a second plurality of data sets in the recording mode and deriving a first relational expression of measured results to front photodiode signals in the reproducing mode and a second expression of measured results to front photodiode signals in the recording mode based on the first and second pluralities of collected data sets, respectively, wherein:
each data set includes a value corresponding to the front diode signal and a value corresponding to the measured result of the power of the laser beam obtained at a different power level of the laser diode.

8. The laser beam power studying system as set forth in claim 7, further comprising:
a first multiplexer selectively inputting the first and second shifted values, and
a second multiplexer selectively inputting values to control the first and second gains of the amplifier.

9. The laser beam power studying system as set forth in claim 8, further comprising:
a third multiplexer selectively inputting a first offset value to the amplifier in the reproducing mode and a second offset value to the amplifier in the recording mode.

10. The laser beam power studying system as set forth in claim 7, further comprising:
a first multiplexer selectively inputting the first and second shifted values, and
a second multiplexer selectively inputting a first offset value to the amplifier in the reproducing mode and a second offset value to the amplifier in the recording mode.

11. The laser beam power studying system as set forth in claim 7, further comprising:
a first multiplexer selectively inputting a first offset value to the amplifier in the reproducing mode and a second offset value to the amplifier in the recording mode, and
a second multiplexer selectively inputting values to control the first and second gains of the amplifier.

12. A laser beam power studying system for studying laser beam power in a reproducing mode and a recording mode, the system having a laser diode selectively driven at a reproducing power level or a recording power level, respectively, the studying system comprising:
a laser beam power meter measuring a power of a first part of the emitted laser beam and outputting a measured result;
a front photodiode measuring a second part of the emitted laser beam and outputting a corresponding signal;
an amplifier shifting a level of the front photodiode signal by a selected value and amplifying the shifted front photodiode signal by a selected gain;
a multiplexer system selectively inputting signals to control the selected value and the selected gain of the amplifier; and
a microcomputer:
controlling the inputting of the signals to control the selected value and the selected gain, and
deriving a relational expression from a plurality of data sets of measured results and corresponding front photodiode signals, wherein:
each data set includes a value corresponding to the front diode signal and a value corresponding to the measured result at a same power level of the laser diode, and
the plurality of data sets includes a first predetermined number of data sets corresponding to the laser beam power in the reproducing mode and a second predetermined number of data sets corresponding to the laser beam power in the recording mode.

13. The laser beam power studying system as set forth in claim 12, wherein:
the plurality of data sets includes at least three data sets corresponding to the laser beam power in the reproducing mode.

14. The laser beam power studying system as set forth in claim 12, wherein:
the plurality of data sets includes at least three data sets corresponding to the laser beam power in the recording mode.

15. The laser beam power studying system as set forth in claim 12, wherein:
the plurality of data sets includes at least three data sets corresponding to the laser beam power in the reproducing mode and at least three data sets corresponding to the laser beam power in the recording mode.
